(19) United States
(12) Patent Application Publication
(10) Pub. No.: US 2010/0189440 A1
(43) Pub. Date: Jul. 29, 2010

(54) Methods and Systems for Transmitting Data in Scalable Passive Optical Networks

(75) Inventors: Martin Julien, Laval (CA); Robert Brunner, Montreal (CA); David Gordon, Montreal (CA); Ludovic Beliveau, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/360,958

(22) Filed: Jan. 28, 2009

(51) Int. Cl. H04J 14/02

(52) U.S. Cl. 398/79

(57) ABSTRACT

Systems and methods according to these exemplary embodiments provide for methods and systems that enable decoupling of medium access control (MAC) functions from other optical transceiver functions to, for example, promote scalability of passive optical networks (PONs). A MAC frame processing unit can communicate MAC frames to optical transceiver modules via an interconnect using an encapsulating frame according to another communications protocol, e.g., XAUI.

### TECHNICAL FIELD

The present invention relates generally to telecommunications systems and in particular to methods and systems for transmitting data in passive optical networks.

### BACKGROUND

Communications technologies and uses have greatly changed over the last few decades. In the fairly recent past, copper wire technologies were the primary mechanism used for transmitting voice communications over long distances. As computers were introduced the desire to exchange data between remote sites became desirable for many purposes such as those of businesses, individual users and educational institutions. The introduction of cable television provided additional options for increasing communications and data delivery from businesses to the public. As technology continued to move forward, digital subscriber line (DSL) transmission equipment was introduced which allowed for faster data transmissions over the existing copper phone wire infrastructure. Additionally, two way exchanges of information over the cable infrastructure became available to businesses and the public. These advances have promoted growth in service options available for use, which in turn increases the need to continue to improve the available bandwidth for delivering these services, particularly as the quality of video and overall amount of content available for delivery increases.

One promising technology that has been introduced is the use of optical fibers for telecommunication purposes. Optical fiber network standards, such as synchronous optical networks (SONET) and the synchronous digital hierarchy (SDH) over optical transport (OTN), have been in existence since the 1980s and allow for the possibility to use the high capacity and low attenuation of optical fibers for long haul transport of aggregated network traffic. These standards have been improved upon and today, using OC-768/STM-256 (versions of the SONET and SDH standards respectively), a line rate of 40 gigabits/second is achievable using dense wave division multiplexing (DWDM) on standard optical fibers.

In the access domain, information regarding optical networking can be found in Ethernet in the First Mile (EFM) standards (IEEE 802.3ah which can be found at www.ieee802.org and is included herein by reference) supporting data transport over point-to-point (p2p) and point-to-multipoint (p2 mp) optical fiber based access network structures. Additionally the International Telecommunications Union (ITU) has standards for p2 mp relating to the use of optical access networking. Networks of particular interest for this specification are passive optical networks (PONs). For example, three PONs of interest are, e.g., Ethernet PONs (EPONs), broadband PONs (BPONs) and gigabit capable PONs (GPONs), various exemplary characteristics of which are displayed below for comparison in Table 1.

TABLE 1
Major PON Technologies and Properties

| Characteristics | EPON | BPON | GPON |
|---|---|---|---|
| Standard | IEEE 802.3ah | ITU-T G.983 | ITU-T G.984 |
| Protocol | Ethernet | ATM | Ethernet |
| Rates (Mbps) | 1244 up/1244 | 622/1244 down | 1244/2488 down |
| | down | 155/622 up | 155 to 2488 up |
| Span (Km) | 10 | 20 | 20 |
| Number of Splits | 16 | 32 | 64 |

With these ongoing improvements in optical networks, many telecommunication companies are choosing to upgrade their copper centric access networks with fiber optic access networks. Some such upgrades include, for example, using one of the above described PON networks combined with fiber to the home (FTTH), and/or hybrid networks, e.g., fiber to the cabinet (FTTC) combining optical EFM and/or PON for data backhaul with very high speed digital subscriber line (VDSL2) by reusing the last hundred meters or so of copper wire. These upgrades allow an increase in the types and quality of services delivered by companies to end users. As such services are deployed, there will be more demand for these networks and it will be desirable to be able to deploy PONs which are, for example, both flexible, e.g., from a manufacturing and supplier perspective, and scalable to meet this demand.

### SUMMARY

Systems and methods according to the present invention address this need and others by facilitating scalability in passive optical networks (PONs).

According to one exemplary embodiment a method for optical communications an optical communication system includes a first printed circuit board including a medium access control (MAC) unit for generating MAC frames to be transmitted over the optical communication system, a second printed circuit board including elements of an optical transceiver module for receiving the MAC frames and transmitting the MAC frames; an interconnect which connects the first printed circuit board to the second printed circuit board to enable the MAC frames to be communicated from said MAC unit to the optical transceiver module via a predetermined communication protocol, wherein the first printed circuit board further includes logic for processing the MAC frames in accordance with the predetermined communication protocol into other frames for communication over the interconnect and the second printed circuit board further includes logic for processing the other frames to extract said MAC frames for transmission.

According to another exemplary embodiment, a method for optical communications includes the steps of: generating MAC frames to be transmitted over the optical communication system, processing the MAC frames in accordance with a predetermined communication protocol into other frames, transmitting the other frames over an interconnect, receiving the other frames, extracting the MAC frames from the other frames, and transmitting the MAC frames over the optical communication system.

According to another exemplary embodiment, a communications node includes a medium access control (MAC) unit for generating Gigabit Passive Optical Network (GPON) transmission convergence layer (GTC) frames to be transmitted by an optical transceiver module, and logic for processing the GTC frames into other frames in accordance with a predetermined communication protocol and for transmitting the other frames toward the optical transceiver module.

According to yet another exemplary embodiment, a communications node includes logic for receiving frames formatted in accordance with a predetermined communication protocol and processing said frames into Gigabit Passive Optical Network (GPON) transmission convergence (GTC) layer frames, and an optical transceiver module for receiving the GTC frames and for processing and optically transmitting the GTC frames.

### BRIEF DESCRIPTION OF THE DRAWINGS

The accompanying drawings illustrate exemplary embodiments, wherein:

FIG. 1 depicts a Gigabit Passive Optical Network (GPON) in which exemplary embodiments can be implemented;

FIG. 2 illustrates Optical Network Units (ONUs) of FIG. 1 using a time division multiple access (TDMA) scheme to communicate with an associated Optical Line Termination (OLT);

FIG. 3(a) shows a conventional GPON protocol stack;

FIG. 3(b) illustrates a conventional GPON transmission convergence (GTC) frame;

FIG. 4 depicts a conventional arrangement including an optical transceiver module and GTC frame processing module disposed on the same printed circuit board;

FIG. 5 illustrates optical transceiver modules decoupled from their corresponding GTC frame processing module according to an exemplary embodiment;

FIGS. 6(a)-6(c) show GTC frames being carried via other frames according to exemplary embodiments; and

FIG. 7 is a flowchart illustrating a method for optical communications according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

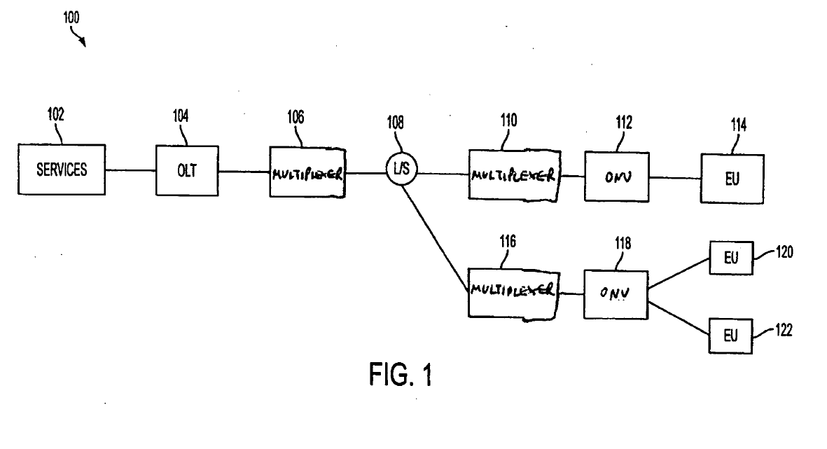

According to exemplary embodiments it is desirable to provide mechanisms and methods that will, among other things, facilitate scalability of a passive optical network (PON). In order to provide some context for this discussion, an exemplary Gigabit-capable PON (GPON) is shown in FIG. 1. While a GPON is used as the basis of discussion herein, other types of PONs, e.g., Ethernet PONs (EPONs) and broadband PONs (BPONs), could benefit from the exemplary embodiments described below with minor variations as would be understood by one skilled in the art. Moreover, although the following examples focus, to some extent, on downstream transmissions in PONs, it will be appreciated that the present invention is equally applicable to upstream transmissions in PONs.

According to exemplary embodiments, GPON 100 in FIG. 1 shows elements of an optical distribution network (ODN) that interact with various endpoints of an optical network unit (ONU). As shown in FIG. 1, one or more service providers or types 102 can be in communication with an optical line termination (OLT) 104, which is typically located in a central office (CO) (not shown). The OLT 104 provides the network side interface and is typically in communication with at least one ONU 112, 118 (or an optical network termination (ONT) which performs similar functions as an ONU). These service providers 102 can provide a variety of services such as video-on-demand or high definition television (HDTV), Voice over IP (VoIP) and high speed internet access (HSIA). The OLT 104 transmits information to multiplexer 106 which multiplexes the data and transmits the data optically to a passive combiner/splitter 108. The passive combiner/splitter 108 then splits the signal and transmits it to the upstream multiplexers 110 and 116. The multiplexers 110 and 116 demultiplex the signal and forward it on to their respective ONUs 112 and 118. These multiplexers (108, 110 and 116) are typically integrated into both the OLT and the ONUs and are used for placing and extracting the upstream and downstream wavelengths depending upon their locations in the optical network. These ONUs 112 and 118 then forward the information onto their respective end users (EU) 114, 120 and 122, e.g., devices such as a computer, a television, etc. Although only two splits are shown in FIG. 1 to simplify the figure, it will be appreciated that any number of splits N can be provided by splitter 108, e.g., 32 or 64. In the future is envisioned that even more endpoints and splits will be served by each OLT 104, making issues of scalability even more significant for deploying such GPON systems.

It will be understood by those skilled in the art that this purely illustrative GPON 100 can be implemented in various ways, e.g., with modifications where different functions are combined or performed in a different manner. For example the multiplexers (108, 110 and 116) typically are duplexers, but if an additional signal is being transmitted, e.g., a cable-television signal in a GPON 100, they can act as triplexers. Additionally in the upstream direction, the optical signal would typically have a different wavelength from the downstream signal and use the same multiplexers 106, 110 and 116, which have bidirectional capabilities.

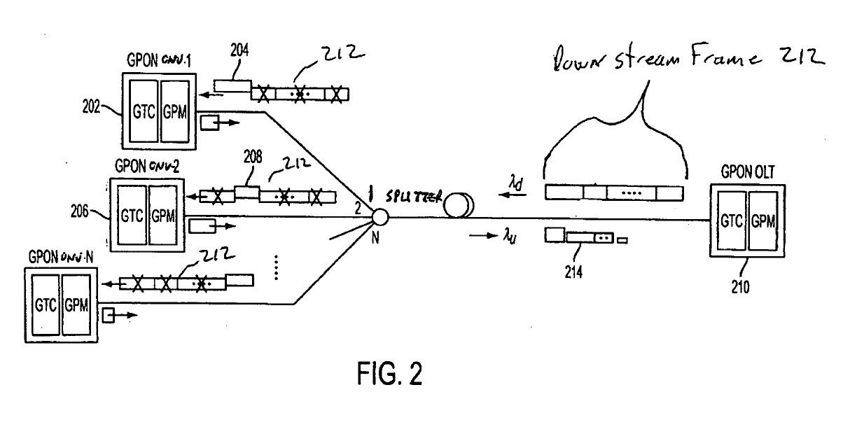

In the upstream direction, a TDMA scheme (e.g., as shown in FIG. 2) is used in a PON where ONUs 202 and 206 are allowed to transmit data in granted time-slots on their optical wavelength(s) within an upstream 125 μs frame. This means that ONUs 202, 206 transmit in a burst mode at their allotted time slots, as compared to an entire 125 μs long frame 212 being transmitted in the downstream direction from the OLT 210. The OLT 210 transmits a 125 μs long frame 212 which is composed of a GPON transmission convergence (GTC) header and a GTC payload. The GTC Payload typically contains a sequence of G-PON Encapsulation Method (GEM) Headers and GEM Payloads, with the GEM Header containing information identifying the destination ONU, e.g., the ONU-ID, and the GEM Payload containing the desired data. Since the ONUs 202, 206 are located at different distances from the OLT 210, the ONTs 202, 206 are informed by the OLT 210 when, and with what power, to transmit their respective bursts so that the ONUs signals are arriving in an aligned time structure at the OLT 210.

Although it is shown in FIG. 2 that each ONU 202, 206 is receiving a single GEM Header/Payload segment within the frame 212 in sequential order, it is possible for an ONU 202, 206 to receive multiple GEM Header/Payload segments within a single downstream frame 212 in whatever order the OLT 210 decides to use since each ONU can filter the downstream data based, e.g., on its assigned ONU-ID. Based on the received data, e.g., an upstream bandwidth map field which is optionally present within the GTC header, the ONUs 202, 206 know their transmission time slot, which results in an upstream message 214 where the different ONU outputs are in a time sequential order.

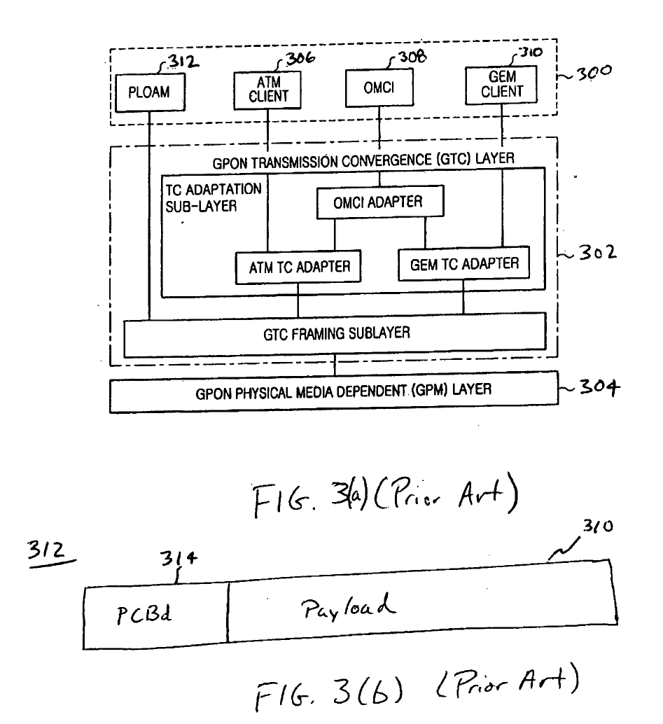

As seen in FIG. 2, each ONT (or ONU) will have components associated with processing data at the various layers in the GPON protocol stack, e.g., the GPON physical media dependent layer (GPM) and the GTC layer. The GPON protocol stack can be conceptualized as described in the ITU Recommendation G.984.3, entitled “Transmission convergence layer specification”, the description of which is incorporated here by reference, and as illustrated in FIG. 3(a). Therein, the conventional protocol stack of the GPON 100 includes a higher level protocol layer 300 which interfaces with an upper layer (not shown), a GTC layer 302, and a GPM layer 304. The protocol layer 300 includes an asynchronous transfer mode (ATM) client 306, an ONT management control interface (OMCI) 308, a GEM client 310, and a physical layer operation administration maintenance (PLOAM) module 312. The GTC layer 302 converts upper layer frames, e.g., ATM or GEM frames, which it receives into a GTC frame and then transmits the GTC frame. In the illustrated, exemplary protocol stack of FIG. 3(a), the GTC layer supports, e.g., both ATM and GEM, although those skilled in the art will appreciate that an implementation could support, for example, either ATM or GEM rather than supporting both by providing only a respective client in layer 300.

More specifically, as shown in FIG. 3(b), the GTC frame packages, e.g., the ATM or GEM frames in payload portions 310 of a GTC frame 312 along with a header 314. In the example of FIG. 3(b), the GTC frame 312 is a downstream frame and therefore has a header denoted PCBd, whereas an upstream GTC frame (not shown) may have, for example, a header denoted PCBu. The PCBd header 314 includes overhead information including, for example, the afore-mentioned upstream bandwidth map used by ONUs to determine their granted time-slots for transmitting upstream traffic during the corresponding upstream GTC time frame. The PCBd header 314 will also include other overhead information as described, for example, in the above-incorporated by reference standard document ITU Recommendation G.984.3.

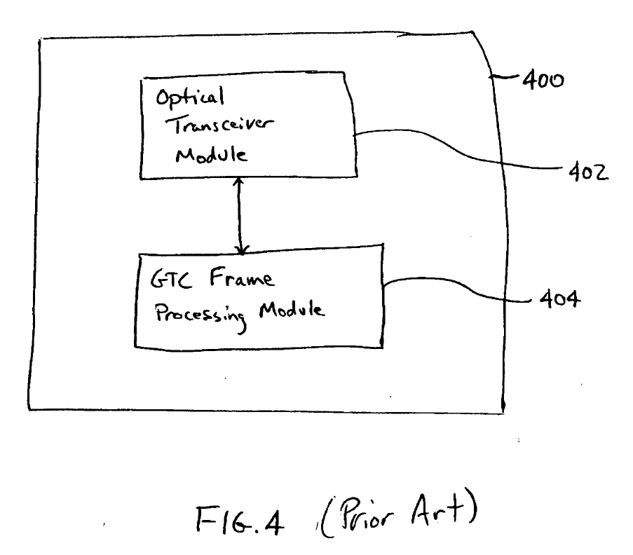

Optical transceivers used to transmit GTC frames 312 in GPONs may be implemented on a printed circuit board (PCB) 400, e.g., disposed in the OLTs 104 of a GPON, including various modules as shown in FIG. 4. Therein, an optical transceiver module 402 may include, for example, an optical modulator and a laser for modulating GTC frames received from the GTC frame processing module 404. Those skilled in the art will appreciate that PCB 400 will typically include other components associated with transmission and reception of data in a GPON, e.g., electrical/optical (E/O) conversion units, optical/electrical (O/E) conversion units, memory devices, controllers, and line interface units, however such additional components are omitted to simplify the figure.

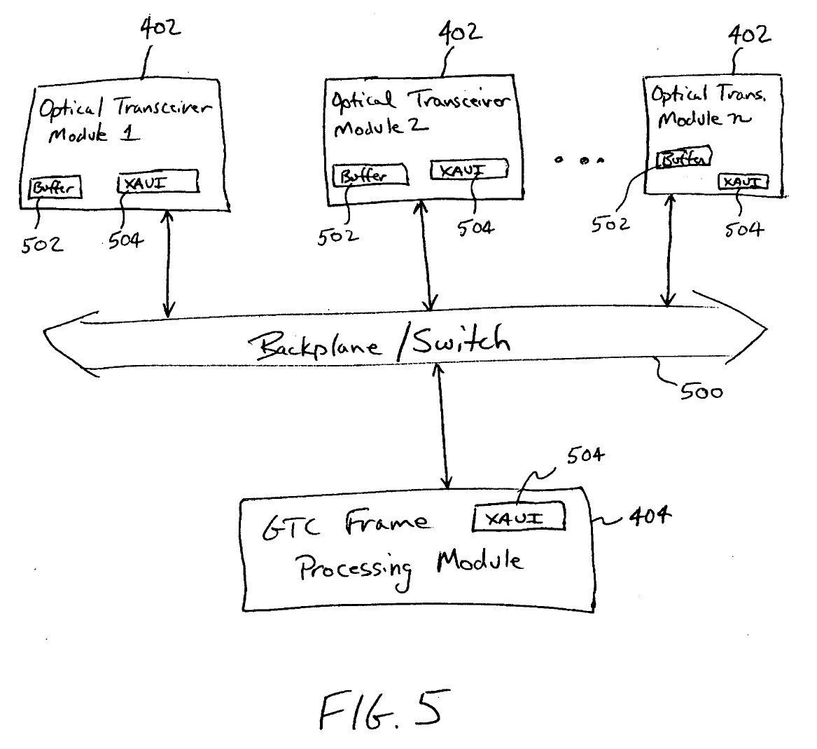

According to exemplary embodiments, in order to, for example, support scalability of GPONs, it may be desirable to separate the GTC frame processing module 404 (or, more generally, the medium access control (MAC) frame processing module) from the optical transceiver module(s) 402 which it supports as shown in FIG. 5. Among other things, as shown, this will enable a single GTC frame processing module 404 to potentially support a plurality of optical transceiver modules 402 via a backplane 500 or other interconnect to facilitate scaling of the GPONs, e.g., as additional ONUs are added per OLT. Thus it will be appreciated that the optical transceiver module(s) 402 may be disposed in one node or on a first printed circuit board, while the GTC frame processing module is disposed in another node or on a second printed circuit board according to these exemplary embodiments. The two printed circuit boards can be disposed within the same chassis or node. For embodiments wherein multiple optical transceiver modules 402 are supplied with MAC frames from a single GTC frame processing unit 404, such optical transceiver modules may be disposed on the same PCB or on different PCBs and each of the optical transceiver modules 402 can have their own, respective MAC function, albeit each of the MAC functions will be located on, or supported by, the same, single GTC frame processing unit 404. However, it should be appreciated by those skilled in the art that exemplary embodiments of the present invention are equally applicable to implementations wherein there is a 1:1 relationship between the optical transceiver modules 402 and the GTC frame processing modules 404, e.g., to provide additional supplier and manufacturing flexibility.

As shown in FIG. 5, the optical transceiver modules 402 according to such exemplary embodiments will also include an additional receive buffer (B) 502 in order to receive GTC frames over the backplane 500 from the GTC frame processing module 404 and supply them to the other components in the optical transceiver module 402 so as to enable continuous optical data transmission as required in GPON systems. Thus the receive buffers 502, and corresponding communications between the buffers 502 and the GTC frame processing module, should be implemented such that these buffers do not become empty.

In addition to these modifications, exemplary embodiments also need to employ a transport mechanism over which the GTC frames can be carried from the GTC frame processing module 404 over the backplane (or other interconnect) 500 and to the desired one of the optical transceiver modules 402. Conventionally, when the optical transceiver module 402 and the GTC frame processing module 404 were disposed on the same PCB 400, no such transport mechanism was necessary. Selecting a suitable transport mechanism for this purpose requires consideration of the transmission requirements of the GPON system itself, since the selected transport mechanism must permit the GPON system to transmit its GTC frames as set forth in the standard, i.e., the use of the intermediate transport mechanism according to these exemplary embodiments to transport the GTC frames from the now remotely located GTC frame processing module 404 to the appropriate optical transceiver module 402 via the backplane/switch 500 should not impact the transmission requirements of the GPON system. In part, this can be accommodated by the provision of the GTC receive buffers 502. However the overhead and other characteristics of the transport protocol should also be considered to ensure that they do not conflict with GPON requirements.

According to exemplary embodiments, Applicants have determined that one protocol which can be used to transport GTC frames as described above is the XAUI standard, specified in the IEEE 802.3ae standards document, the disclosure of which is incorporated here by reference. Briefly, XAUI is conventionally used as a mechanism for connecting a 10 Gigabit Ethernet physical layer to an Ethernet MAC layer on a PCB, however these exemplary embodiments propose using XAUI to encapsulate GTC frames for transport over an architecture such as that shown in FIG. 5. Among other things described in the above-incorporated by reference standards document, XAUI provides a 16-pin interface consisting of four differential lanes in both the transmit and receive directions wherein data is 8b10b encoded resulting in a data-rate of 3.125 GHz per lane. Thus the exemplary embodiment of FIG. 5 also includes XAUI processing units 504 for adding/removing the overhead associated with XAUI data packets and processing the GTC frames for transmission and reception via XAUI payload sections.

Selection of XAUI as a transport protocol for GTC frames in the exemplary embodiment of FIG. 5 included, for example, the following considerations. By its nature, the 10G GPON specification requires frames to be sent at a constant rate with a fixed time length. From that perspective, the 10G GPON specification does not require any fragmentation or overhead besides that set forth in the GPON's GTC specification itself. On the other hand, the XAUI protocol operates on a per burst of data basis, which means that it is not required to be sent at a constant rate but, in order to account for the discontinuity of the data stream, XAUI does employ a protocol overhead. Thus an initial inquiry involved determining whether the extra overhead to be added by XAUI exceeds the capability of the GPON transmission requirements to accommodate more overhead bits and whether there would be any fragmentation issues. XAUI has a downstream data rate of 10 Gbps, and an upstream data rate of 10 Gbps, while a currently suggested standard for 10G GPON has a downstream data rate of 9.95328 Gbps and an upstream data rate of 2.48832 Gbps.

Regarding overhead, and based on a data rate of 10 Gbps and a constant frame length of 125 us, every frame on XAUI has a constant frame size of 156250 bytes, i.e., 10 Gbps/8 bits*125 us=156250 bytes. This means that a 10G GPON GTC frame can be carried over XAUI including a maximum of 730 bytes of overhead, i.e., 156250 B−155520 B=730 bytes, where 155520 B is the downstream GTC frame size calculated as 9.95328 Gbps/8 bits*125 us=155520 bytes. A XAUI data frame is delimited by a /S/—“SOP—Start of Packet” control character (which must be sent on lane-0) and a /T/—“EOP—End of Packet” control character and, therefore, XAUI data frames have only 2 bytes of overhead. This, among other things, makes XAUI a good choice as a protocol to carry the GTC frames between decoupled GTC frame processing units 404 and the optical transceiver modules 402 which they are supplying with GTC frames. Depending on the vendor of the XAUI silicon, the XAUI data frames can be sent back-to-back, over short electrical distances, without an inter-frame gap. Again, depending on the vendor of the XAUI silicon, handling of 64K+ bytes of XAUI data frames is typical. Other specific issues associated with overhead in the context of using various protocols or combinations of protocols to carry the GTC frames between the GTC frame processing unit 404 and the optical transceiver module(s) 402 according to these exemplary embodiments are discussed below.

Regarding fragmentation issues, taking into account that typical XAUI implementations support a maximum frame size of approximately 64 kB, and that a 10G GPON frame size is 155520 bytes, fragmentation will be required in order to transport a GPON frame over XAUI. In order to help in providing a constant data rate for fragmented GPON frames, the prime factorization of the 10G GPON frame size is:

155520=2×2×2×2×2×2×2×3×3×3×3×3×5

This prime factorization can be useful in order to control the amount of overhead used when fragmenting the GTC frames, as it is easier to control the maximum allowed overhead by fragmenting GTC frames with constant sized fragments. Based on the foregoing analysis, it can be seen that GTC frames can be transported over XAUI between the non-colocated GTC frame processing module 404 and the optical transceiver modules 402 according to these exemplary embodiments. The resulting frames will be, for example, stripped of their XAUI overhead and have their payloads concatenated to reform the GTC frames by the XAUI processing units or logic 504, prior to being loaded into their respective buffers 502 for transmission.

Numerous variations and modifications to the above-described exemplary embodiments are contemplated and within the scope of the present invention. For example, a scalable GPON which decouples the optical transceiver module 402 from the GTC frame processing module 404 can be implemented with a receive buffer. Such a buffer implementation can use an adaptive rate limiting scheme wherein one or more IDLE patterns are injected into the output stream of the GTC frame processing module 404 to compensate for what would otherwise be a potential buffer over-flow condition at the optical transceiver module 402. Similarly, fewer or no IDLE patterns can be injected to avoid a potential buffer under-flow condition. This technique for selectively throttling the bandwidth when transmitting GTC frames over XAUI takes advantage of the capability provided in XAUI to tune the interframe gap which is provided between XAUI data frames. For example, according to one exemplary embodiment, FIFO “high/low” watermark settings trigger a rate limiting message (e.g., a single bit), toggling high/low data rates between the GTC frame processing module 404 and the optical transceiver module 402. More specifically, a receive buffer reacts to a “high/low” watermark threshold, and forwards a rate limiting message towards the remote sender. The remote sender, upon reception of a rate limiting message, throttles its transmission rate by inserting IDLE patterns between data frames. The rate limiting message can be sent as a standalone data frame, or optionally embedded in the GTC frame at intervals of N-bytes (which could be useful for symmetrical 10G/10G).

Although a considered selection of the transport protocol to be used for carrying GTC frames is suggested by these exemplary embodiments, and the XAUI protocol described above is one candidate, the present invention is not limited to the use of XAUI. For example, the 10 Gigabit Media Independent Interface (XGMII) can be used as an alternative protocol. XGMII is specified for a 32-bit wide data bus (4 byte wide bus), whereas XAUI is specified for a 4 lane bus, such that one XGMII byte of data is equivalent to 1 XAUI lane of serialized data of 10-bits. Additionally, GTC over another protocol over XAUI can be used according to other exemplary embodiments to provide connectivity between one GTC frame processing module 404 to many optical transceiver modules 402, where the other protocol is a switching protocol such as Ethernet, Serial-Rapid-IO, SPI-4.2 or HyperTransport.

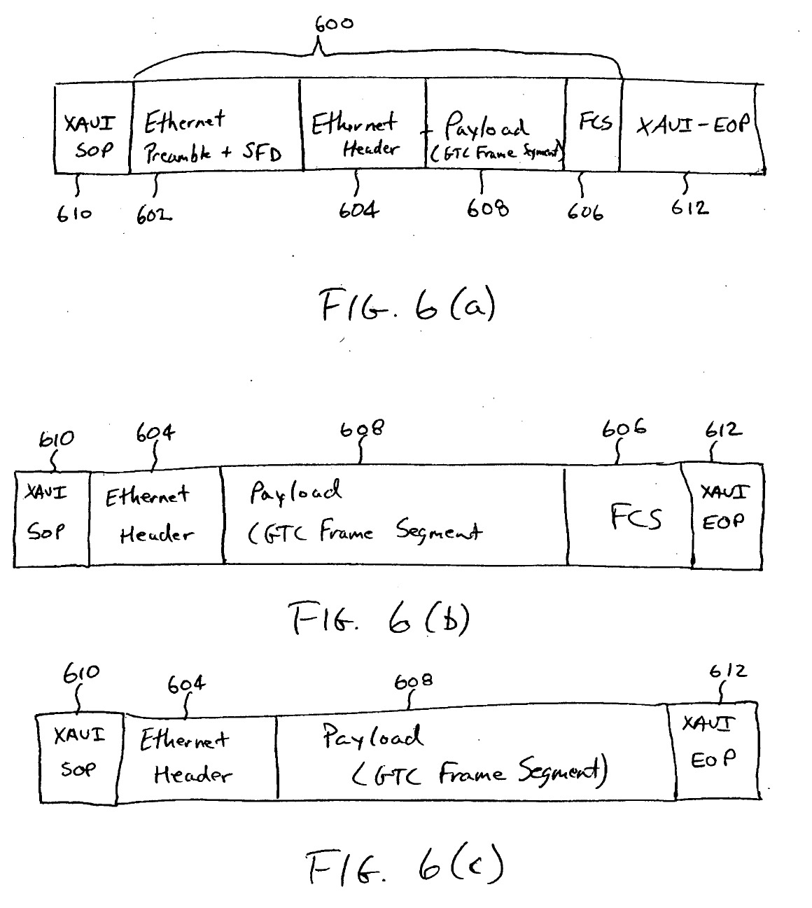

For example, according to one exemplary embodiment, a GPON's GTC frame can be carried over XAUI encapsulated in an Ethernet packet 600 between the GTC frame processing module 404 and the optical transceiver module 402 as shown conceptually in FIG. 6(a). In such an exemplary embodiment, the complete frame structure includes a XAUI SOP field 610, an Ethernet preamble and start-of-frame delimiter (SFD) 602, Ethernet header 604 (i.e., including a destination MAC address, a source MAC address and a length field), a payload portion (including a GTC frame segment), a Frame Check Sequence (FCS) 606, and a XAUI EOP field 612. This means consideration of various overhead including XAUI SOP (1 byte), XAUI EOP field (1 byte), Ethernet preamble and SFD (7+1=8 bytes), Ethernet header (14 bytes, i.e., no VLAN) and FCS (4 bytes), in addition to which there can be an interframe gap (IFG) of, for example, 12 bytes. Thus, considering the overhead bytes related to XAUI, the Ethernet encapsulation, the IFG and the maximum overhead budget allowed on XAUI as shown by equations (1) and (2) below, a GPON's GTC frame which is transported using XAUI encapsulated in an Ethernet frame can be split into a maximum of 18 frames of constant frame size of 8640 bytes.

730 bytes/(1+1+8+14+4+12) bytes=18.25 frames (1)

155520 bytes/18 frames=8640 bytes per frame (2)

Note that in this particular example, which assumes that an Ethernet switch is interconnecting the different modules, an IFG of 12 bytes is specified. However it will be appreciated by those skilled in the art that an implementation which uses different equipment vendors or system configurations could lead to much lower values of overhead associated with the IFG, which would make the available bandwidth utilization even more efficient. The IFG depends on, for example, how much time each user of the communication link requires between frames, also considering that for XAUI, a SOP is required to be on lane 0.

According to another exemplary embodiment, illustrated in FIG. 6(b), a GPON's GTC frame is carried over XAUI without an Ethernet preamble and SFD 602 but with an FCS 606 between the GTC frame processing module 404 and the optical transceiver module 402. As mentioned above, an FCS 606 adds 4 bytes to the overhead per frame. Again, considering the overhead bytes related to XAUI via header 608 and the FCS 606, and the maximum overhead budget allowed on XAUI, a GPON's GTC frame according to this exemplary embodiment can be split into a maximum of 20 frames of constant frame size of 7776 bytes as shown by equations (3) and (4) below.

730 bytes/(1+1+14+4+12) bytes=22.81 frames (3)

155520 bytes/20 frames=7776 bytes per frame (4)

According to still another exemplary embodiment, the FCS 606 can be omitted resulting in the exemplary frame structure shown in FIG. 6(c). Considering the overhead bytes related to XAUI in, and the maximum overhead budget allowed on XAUI, a GPON's GTC frame according to such an exemplary embodiment can be split into a maximum of 24 frames of constant frame size of 6480 bytes, as shown by equations (5) and (6) below.

730 bytes/(1+1+14+12) bytes=26.07 frames (5)

155520 bytes/24 frames=6480 bytes per frame (6)

According to still other embodiments, it should be appreciated that protocols other than Ethernet may be used to encapsulate the GTC fragments. For example, the frame structures of FIGS. 6(b) and 6(c) may be modified to replace the Ethernet header 604 with a header in accordance with another protocol and so could be visualized as generic headers.

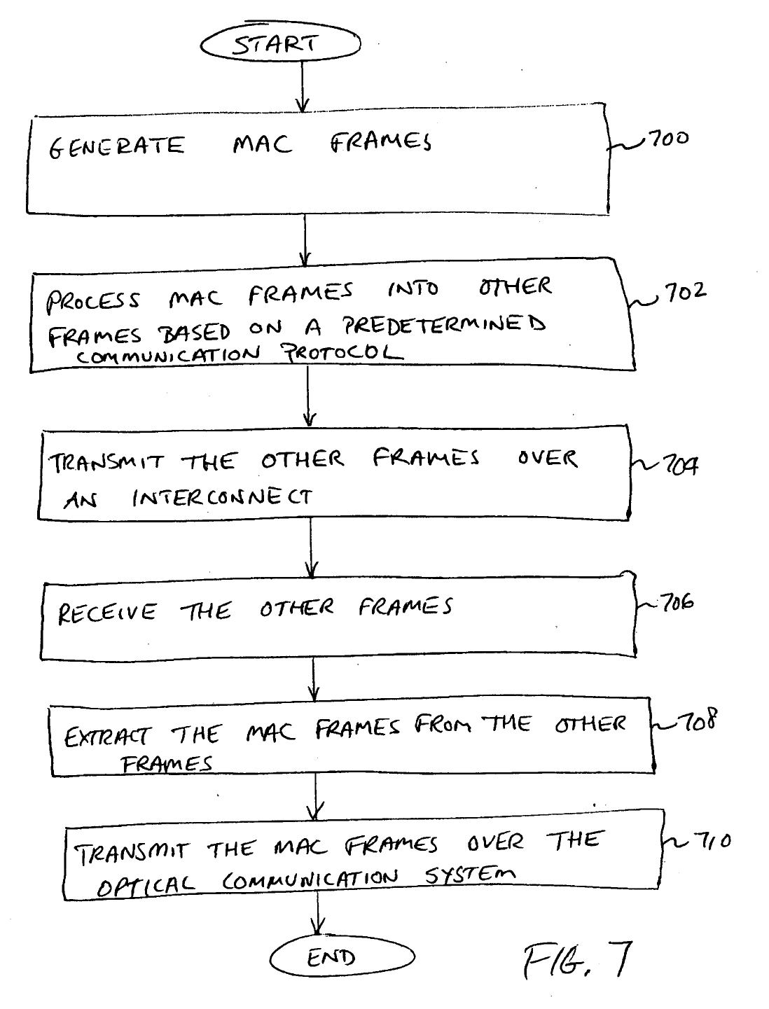

Specifying a mechanism for GTC over XAUI, or another selected protocol, according to these exemplary embodiments allows for greater scalability of PONs. Among other things, this permits separation of the control and MAC functions of the GPON standard, as described above, where the control functions associated with the optical transceiver are provided on a separate processor than that which performs the MAC functions. According to one exemplary embodiment, a method for optical communications includes the steps shown in the flowchart of FIG. 7. Therein, at step 700, MAC frames to be transmitted over the optical communication system are generated. The MAC frames are processed in accordance with a predetermined communication protocol, e.g., XAUI, into other frames at step 702. The other frames are transmitted over an interconnect, e.g., a backplane at step 704, and the received at step 706, e.g., by the optical transceiver module 402. The MAC frames are extracted (and otherwise processed, e.g., segments concatenated to form complete MAC frames) from the other frames at step 708. The resulting MAC frames are then optically transmitted at step 710, e.g., over the optical fiber from an OLT 104 toward an ONU 112.

Various other modifications and details may be included according to exemplary embodiments. For example, the optical transceiver module 402 and GTC frame processing module 404, in addition to the above-described payload data protocol (e.g., XAUI) can also have other interfaces to enable them to communicate with each other (e.g., SERDES Framer Interface (SFI), low voltage differential signaling (LVDS), or the like). The GTC frame processing module 404 can also have some form of memory to buffer the frames to send via the interconnect 500, as well as an interface for configuring GTC framer software (e.g., in accordance with the Joint Test Action Group (JTAG) interface standard). The receiving mechanism used by the optical transceiver module 402 should be a burst mode mechanism, as opposed to a continuous mode mechanism, since the ONUs 118 transmit in bursts and the OLT 104 transmits in continuous mode. In addition to an optical transceiver itself, the optical transceiver modules 402 may also include electronic components such as limiting amplifiers (LIAs) and clock and data recovery (CDR) mechanisms.

Additionally, as mentioned above, although the foregoing exemplary embodiments are described primarily in the context of downstream (OLT to ONU) transmissions, they are equally applicable to upstream (ONU to OLT) transmissions. Although current specifications for upstream transmission require less bandwidth than downstream transmissions, it is possible that future PON specifications will also provide for higher bandwidth on the upstream transmissions and the corresponding challenges to avoid oversubscription of the upstream traffic. Moreover, although one of the foregoing exemplary embodiments refers to the transmission of GTC frames using Ethernet over XAUI, it will be appreciated that the present invention is not so limited. For example, other protocols could be used over XAUI which provide for the specification of a source/destination for directing frames over the interconnect. In the foregoing exemplary embodiments, a complete GTC frame is produced on a first printed circuit board and then transferred to an optical transceiver module on another printed circuit board. However, according to another exemplary embodiment, instead only part of the GTC frame is generated in the MAC module and transmitted to the optical module. For example, GTC headers and GEM headers/payload could be sent independently to optical modules, which would then assemble them into a complete GTC frame.

The above-described exemplary embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. An optical communication system comprising:
a first printed circuit board including a medium access control (MAC) unit for generating MAC frames to be transmitted over said optical communication system;
a second printed circuit board including elements of an optical transceiver module for receiving said MAC frames and transmitting said MAC frames;
an interconnect which connects said first printed circuit board to said second printed circuit board to enable said MAC frames to be communicated from said MAC unit to said optical transceiver module via a predetermined communication protocol,
wherein said first printed circuit board further includes logic for processing said MAC frames in accordance with said predetermined communication protocol into other frames for communication over said interconnect and said second printed circuit board further includes logic for processing said other frames to extract said MAC frames for transmission.

2. The optical communication system of claim 1, wherein said optical transceiver module includes an optical modulator and a laser.

3. The optical communication system of claim 1, wherein said optical communication system is a Gigabit Passive Optical Network (GPON), said MAC unit is a GPON Transmission Convergence (GTC) frame processing unit, and said MAC frames are GTC frames.

4. The optical communication system of claim 1, wherein said predetermined communication protocol is one of XAUI and 10 Gigabit Media Independent Interface (XGMII).

5. The optical communication system of claim 4, wherein said predetermined communication protocol is used to generate said another frame and said another frame is encapsulated in an Ethernet frame.

6. The optical communication system of claim 4, wherein a frame check sequence (FCS) is added to each of said another frames.

7. The optical communication system of claim 1, wherein said second printed circuit board includes a buffer for holding said MAC frames for transmission after they have been extracted by said logic for processing said other frames to ensure continuous transmission of said MAC frames by said optical transceiver module.

8. The optical communication system of claim 1, further comprising:
a bandwidth throttling mechanism for selectively inserting IDLE patterns between said other frames to ensure continuous transmission of said MAC frames by said optical transceiver module.

9. The optical communication system of claim 1 further comprising:
a third printed circuit board including elements of an optical transceiver module for receiving other frames from said first printed circuit board, extracting associated MAC frames from said other frames, and transmitting said associated MAC frames.

10. The optical communication system of claim 1, wherein said first and second printed circuit boards are disposed within an optical line termination (OLT) unit.

11. The optical communication system of claim 1, wherein said first and second printed circuit boards are disposed within an optical network unit (ONU).

12. A method for optical communications comprising:
generating MAC frames to be transmitted over said optical communication system;
processing said MAC frames in accordance with a predetermined communication protocol into other frames;
transmitting said other frames over an interconnect;
receiving said other frames;
extracting said MAC frames from said other frames; and
transmitting said MAC frames over said optical communication system.

13. The method of claim 12, wherein said optical communication system is a Gigabit Passive Optical Network (GPON), said MAC unit is a GPON Transmission Convergence (GTC) frame processing unit, and said MAC frames are GTC frames.

14. The method of claim 12, wherein said predetermined communication protocol is one of XAUI and 10 Gigabit Media Independent Interface (XGMII).

15. The method of claim 14, further comprising:
encapsulating said other frames in Ethernet frames.

16. The method of claim 14, further comprising:
adding a frame check sequence (FCS) to each of said other frames.

17. The method of claim 12, further comprising:
buffering said MAC frames for transmission after they have been extracted to ensure continuous transmission of said MAC frames.

18. The method of claim 12, further comprising:
selectively inserting IDLE patterns between said other frames to ensure continuous transmission of said MAC frames.

19. The method of claim 12, wherein said step of transmitting said MAC frames over said optical communication system occurs in a downstream direction.

20. The method of claim 12, wherein said step of transmitting said MAC frames over said optical communication system occurs in an upstream direction.

21. A communications node comprising:
a medium access control (MAC) unit for generating Gigabit Passive Optical Network (GPON) transmission convergence layer (GTC) frames to be transmitted by an optical transceiver module; and
logic for processing said GTC frames into other frames in accordance with a predetermined communication protocol and for transmitting said other frames toward said optical transceiver module.

22. The communications node of claim 21, wherein said other frames are transmitted over an interconnect toward said optical transceiver module.

23. A communications node comprising:
logic for receiving frames formatted in accordance with a predetermined communication protocol and processing said frames into Gigabit Passive Optical Network (GPON) transmission convergence (GTC) layer frames; and
an optical transceiver module for receiving said GTC frames and for processing and optically transmitting said GTC frames.

24. The communications node of claim 23, wherein said GTC frames are received over an interconnect.
